(19) United States
(12) Patent Application Publication
(10) Pub. No.: US 2016/0180092 A1
(43) Pub. Date: Jun. 23, 2016

(54) PORTABLE SECURE STORAGE

(71) Applicant: McAfee, Inc., Santa Clara, CA (US)

(72) Inventor: Erdem Aktas, Beaverton, OR (US)

(73) Assignee: McAfee, Inc., Santa Clara, CA (US)

(21) Appl. No.: 14/581,866

(22) Filed: Dec. 23, 2014

(51) Int. Cl. G06F 21/56

(52) U.S. Cl. CPC G06F 21/567; G06F 21/568; G06F 21/562; G06F 2221/033; G06F 2221/034

(57) ABSTRACT

Particular embodiments described herein provide for a portable electronic device that can be configured to receive data from an electronic device, where the portable electronic device is removably connected to the electronic device and receives its operating power from the electronic device. The portable electronic device can analyze the data using at least a portion of a protected area of memory located in the portable electronic device to determine if the data is malicious, where the protected area of memory is not accessible by the electronic device. The portable electronic device can also include an operating system and processor that is independent of an operating system of the electronic device.

### TECHNICAL FIELD

This disclosure relates in general to the field of information security, and more particularly, to portable secure storage.

### BACKGROUND

The field of network security has become increasingly important in today's society. The Internet has enabled interconnection of different computer networks all over the world. In particular, the Internet provides a medium for exchanging data between different users connected to different computer networks via various types of client devices. While the use of the Internet has transformed business and personal communications, it has also been used as a vehicle for malicious operators to gain unauthorized access to computers and computer networks and for intentional or inadvertent disclosure of sensitive information.

Malicious software (“malware”) that infects a host computer may be able to perform any number of malicious actions, such as stealing sensitive information from a business or individual associated with the host computer, propagating to other host computers, and/or assisting with distributed denial of service attacks, sending out spam or malicious emails from the host computer, etc. Hence, significant administrative challenges remain for protecting computers and computer networks from malicious and inadvertent exploitation by malicious software and devices.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram of a communication system that includes portable secure storage in accordance with an embodiment of the present disclosure;

FIG. 2 is a simplified block diagram of a portion of a communication system that includes portable secure storage in accordance with an embodiment of the present disclosure;

FIG. 3 is a simplified flowchart illustrating potential operations that may be associated with the communication system in accordance with an embodiment;

FIG. 4 is a simplified flowchart illustrating potential operations that may be associated with the communication system in accordance with an embodiment;

FIG. 5 is a block diagram illustrating an example computing system that is arranged in a point-to-point configuration in accordance with an embodiment;

FIG. 6 is a simplified block diagram associated with an example ARM ecosystem system on chip (SOC) of the present disclosure; and

FIG. 7 is a block diagram illustrating an example processor core in accordance with an embodiment.

The FIGURES of the drawings are not necessarily drawn to scale, as their dimensions can be varied considerably without departing from the scope of the present disclosure.

### DETAILED DESCRIPTION OF EXAMPLE EMBODIMENTS

### Example Embodiments

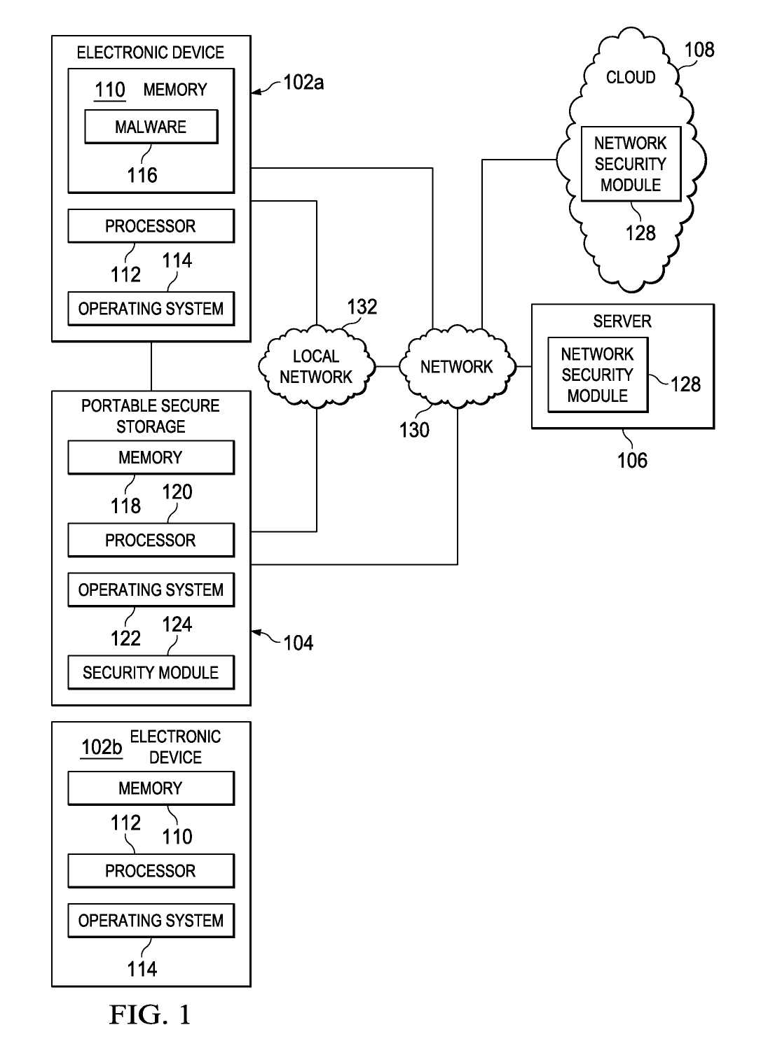

FIG. 1 is a simplified block diagram of a communication system 100 for portable secure storage through network characteristics in accordance with an embodiment of the present disclosure. As illustrated in FIG. 1, an embodiment of communication system 100 can include electronic devices 102a and 102b, a portable secure storage device 104, a server 106, and a cloud 108. Each electronic device 102a and 102b can include memory 110, a processor 112, and an operating system (OS) 114. In one example, memory 110 may include malware 116. Portable secure storage device 104 can include portable memory 118, a portable processor 120, a portable OS 122, and a security module 124. Server 106 and cloud 108 can each include a network security module 128.

Electronic devices 102a and 102b, portable secure storage device 104, server 106, and cloud 108 may be in communication using network 130. Electronic devices 102a and 102b can each be in communication with portable secure storage device 104 using a physical connection or a wireless connection, such as a local network 132 (e.g., a personal area network (PAN)).

In example embodiments, portable secure storage device 104 can be configured to be connected to electronic device 102a, then easily removed or disconnected and connected to electronic device 102b. The form factor of portable secure storage device 104 is such that it can be transported relatively easily by a user (e.g., thumb drive, universal serial bus (USB) flash drive, or some other device that can fit in a pocket or purse of a user). Portable secure storage device 104 can be configured to scan data for known malware and viruses independent of the trust relationship to the host machine it is connected. For example, portable OS 122 can allow portable secure storage device 104 to operate independent of the operating system of the device (e.g., electronic device 102a or 102b) to which portable secure storage device 104 is connect. Security module 124 can access portable memory 118 which is independent and separate from memory 110 in the device to which portable secure storage device 104 is connect. As a result, if the device to which portable secure storage device 104 is connected is corrupted or includes malware, the malware cannot affect portable secure storage device 104. Portable secure storage device 104 can b updated with new or current malware detection capabilities from network security module 128 using network 130.

Elements of FIG. 1 may be coupled to one another through one or more interfaces employing any suitable connections (wired or wireless), which provide viable pathways for network (e.g., network 130 and local network 132.) communications. Additionally, any one or more of these elements of FIG. 1 may be combined or removed from the architecture based on particular configuration needs. Communication system 100 may include a configuration capable of transmission control protocol/Internet protocol (TCP/IP) communications for the transmission or reception of packets in a network. Communication system 100 may also operate in conjunction with a user datagram protocol/IP (UDP/IP) or any other suitable protocol where appropriate and based on particular needs.

For purposes of illustrating certain example techniques of communication system 100, it is important to understand the communications that may be traversing the network environment. The following foundational information may be viewed as a basis from which the present disclosure may be properly explained.

A portable storage device (PSD) is a small hard drive designed to hold any kind of digital data. In known PSDs, the storage system does not have any processing unit inside and scanning/policy enforcing is done through the drivers installed on the host machine (e.g., electronic device 102a and 102b). If the host machine is compromised, the PSD will also be compromised. For this reason, PSDs generally lack a practical trusted storage that can encrypt/decrypt itself without exporting the keys to the host machines.

Some electronic devices, (e.g., desktop computers, laptop computers, etc) include a trusted platform module (TPM). Unfortunately, TPMs are slow processing units that are not portable and have a very limited storage area and in most cases, are used only for secure storage area for keys. Traditionally, data going to and from the PSD is scanned by the host machine but if the host machine is already compromised, the malware might copy itself to the PSD. What is needed is a portable secure storage device that does not depend on the host machine for the detection of malware.

A communication system that includes a portable secure storage device, as outlined in FIG. 1 can resolve these issues (and others). Communication system 100 may be configured to include a portable secure storage device (e.g., portable secure storage device 104) that can scan itself for known malware and viruses, support user/enterprise policy configuration, and encryption without leaving any keys to the host electronic device. As a result, a trust can be establish to the portable secure storage device independent of the trust relationship of the electronic device to which storage system is connected.

Portable secure storage device 104 may be almost any storage product including USB devices, solid-state drives (SSD), SSD disks, hard disk drives (HDD), secure digitals (SD), micro SDs for mobile phones and tablets, etc. Using the system, portable secure storage device 104 can be protected on a hardware level, independent of the OS on the electronic device to which it is connected. In an example, the security can be embedding to a storage device, such as a table or cellular phone.

Portable secure storage device 104 can include an embedded processor (e.g., portable processor 120) and a security agent (security module 124) that is monitoring data between portable secure storage device 104 and the host system (e.g., electronic device 102a or 102b). Portable secure storage device 104 can encrypt/decrypt files in real time and can scan files that are stored in the memory (e.g., portable memory 118) of portable secure storage device 104 independent from the host system. When a new file is written to the memory, the security agent can scan the new file and verify that it is not malicious. In addition, the security agent can enforce policies including but not limited to not storing executables, not storing unsigned files, not accessing files outside specific geolocations/networks, and other security policies. Traditionally, storage devices such as PSDs are passive and are accessed by any host machine. The host machine can write any file without any restrictions (other than read/write and host machine OS settings). Using security module 124, portable secure storage device 104 can be protected from malicious attacks by malware 116.

Turning to the infrastructure of FIG. 1, communication system 100 in accordance with an example embodiment is shown. Generally, communication system 100 can be implemented in any type or topology of networks. Network 130 represents a series of points or nodes of interconnected communication paths for receiving and transmitting packets of information that propagate through communication system 100. Network 130 offers a communicative interface between nodes, and may be configured as any local area network (LAN), virtual local area network (VLAN), wide area network (WAN), wireless local area network (WLAN), metropolitan area network (MAN), Intranet, Extranet, virtual private network (VPN), and any other appropriate architecture or system that facilitates communications in a network environment, or any suitable combination thereof, including wired and/or wireless communication. Local network 132 represents a series of points or nodes of interconnected communication paths for receiving and transmitting packets of information that propagate through electronic devices 102a and 102b and portable secure storage device 104. Local network 132 offers a communicative interface between nodes, and may be configured as any local area network (LAN), virtual local area network (VLAN), and any other appropriate architecture or system that facilitates communications in a network environment, or any suitable combination thereof, including wired and/or wireless communication.

In communication system 100, network traffic, which is inclusive of packets, frames, signals, data, etc., can be sent and received according to any suitable communication messaging protocols. Suitable communication messaging protocols can include a multi-layered scheme such as Open Systems Interconnection (OSI) model, or any derivations or variants thereof (e.g., Transmission Control Protocol/Internet Protocol (TCP/IP), user datagram protocol/IP (UDP/IP)). Additionally, radio signal communications over a cellular network may also be provided in communication system 100. Suitable interfaces and infrastructure may be provided to enable communication with the cellular network.

The term “packet” as used herein, refers to a unit of data that can be routed between a source node and a destination node on a packet switched network. A packet includes a source network address and a destination network address. These network addresses can be Internet Protocol (IP) addresses in a TCP/IP messaging protocol. The term “data” as used herein, refers to any type of binary, numeric, voice, video, textual, or script data, or any type of source or object code, or any other suitable information in any appropriate format that may be communicated from one point to another in electronic devices and/or networks. Additionally, messages, requests, responses, and queries are forms of network traffic, and therefore, may comprise packets, frames, signals, data, etc.

In an example implementation, electronic devices 102a and 102b, server 106, and cloud 108 are network elements, which are meant to encompass network appliances, servers, routers, switches, gateways, bridges, load balancers, processors, modules, or any other suitable device, component, element, or object operable to exchange information in a network environment. Network elements may include any suitable hardware, software, components, modules, or objects that facilitate the operations thereof, as well as suitable interfaces for receiving, transmitting, and/or otherwise communicating data or information in a network environment. This may be inclusive of appropriate algorithms and communication protocols that allow for the effective exchange of data or information.

In regards to the internal structure associated with communication system 100, each of electronic devices 102a and 102b, server 106, and cloud 108 can include memory elements for storing information to be used in the operations outlined herein. Each of electronic devices 102a and 102b, server 106, and cloud 108 may keep information in any suitable memory element (e.g., random access memory (RAM), read-only memory (ROM), erasable programmable ROM (EPROM), electrically erasable programmable ROM (EEPROM), application specific integrated circuit (ASIC), etc.), software, hardware, firmware, or in any other suitable component, device, element, or object where appropriate and based on particular needs. Any of the memory items discussed herein should be construed as being encompassed within the broad term ‘memory element.’ Moreover, the information being used, tracked, sent, or received in communication system 100 could be provided in any database, register, queue, table, cache, control list, or other storage structure, all of which can be referenced at any suitable timeframe. Any such storage options may also be included within the broad term ‘memory element’ as used herein.

In certain example implementations, the functions outlined herein may be implemented by logic encoded in one or more tangible media (e.g., embedded logic provided in an ASIC, digital signal processor (DSP) instructions, software (potentially inclusive of object code and source code) to be executed by a processor, or other similar machine, etc.), which may be inclusive of non-transitory computer-readable media. In some of these instances, memory elements can store data used for the operations described herein. This includes the memory elements being able to store software, logic, code, or processor instructions that are executed to carry out the activities described herein.

In an example implementation, portable secure storage device 104, server 106, and cloud 108 of communication system 100, may include software modules (e.g., security module 124 and network security module 128) to achieve, or to foster, operations as outlined herein. These modules may be suitably combined in any appropriate manner, which may be based on particular configuration and/or provisioning needs. In example embodiments, such operations may be carried out by hardware, implemented externally to these elements, or included in some other network device to achieve the intended functionality. Furthermore, the modules can be implemented as software, hardware, firmware, or any suitable combination thereof. These elements may also include software (or reciprocating software) that can coordinate with other network elements in order to achieve the operations, as outlined herein.

Additionally, each of electronic devices 102a and 102b, portable secure storage device 104, server 106, and cloud 108 may include a processor that can execute software or an algorithm to perform activities as discussed herein. A processor can execute any type of instructions associated with the data to achieve the operations detailed herein. In one example, the processors could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an EPROM, an EEPROM) or an ASIC that includes digital logic, software, code, electronic instructions, or any suitable combination thereof. Any of the potential processing elements, modules, and machines described herein should be construed as being encompassed within the broad term ‘processor.’

Electronic devices 102a and 102b can each be a network element and includes, for example, desktop computers, laptop computers, mobile devices, personal digital assistants, smartphones, tablets, or other similar devices. Portable secure storage device 104 can be a portable electronic device that can be connected to electronic device 102a, then easily removed and carried around by a user (e.g., thumb drive, a device with a PSD form factor, etc.). Server 106 can be a network element such as a server or virtual server and can be associated with clients, customers, endpoints, or end users wishing to initiate a communication in communication system 100 via some network (e.g., network 130). The term ‘server’ is inclusive of devices used to serve the requests of clients and/or perform some computational task on behalf of clients within communication system 100. Although network security module 124 is represented in FIG. 1 as being located in server 106 or cloud 108, this is for illustrative purposes only. Network security module 124 could be combined or separated in any suitable configuration. Furthermore, network security module 124 could be integrated with or distributed in another network accessible by server 106 or cloud 108. Cloud 108 is configured to provide cloud services to electronic devices 102a-d and portable secure storage device 104. Cloud services may generally be defined as the use of computing resources that are delivered as a service over a network, such as the Internet. Typically, compute, storage, and network resources are offered in a cloud infrastructure, effectively shifting the workload from a local network to the cloud network.

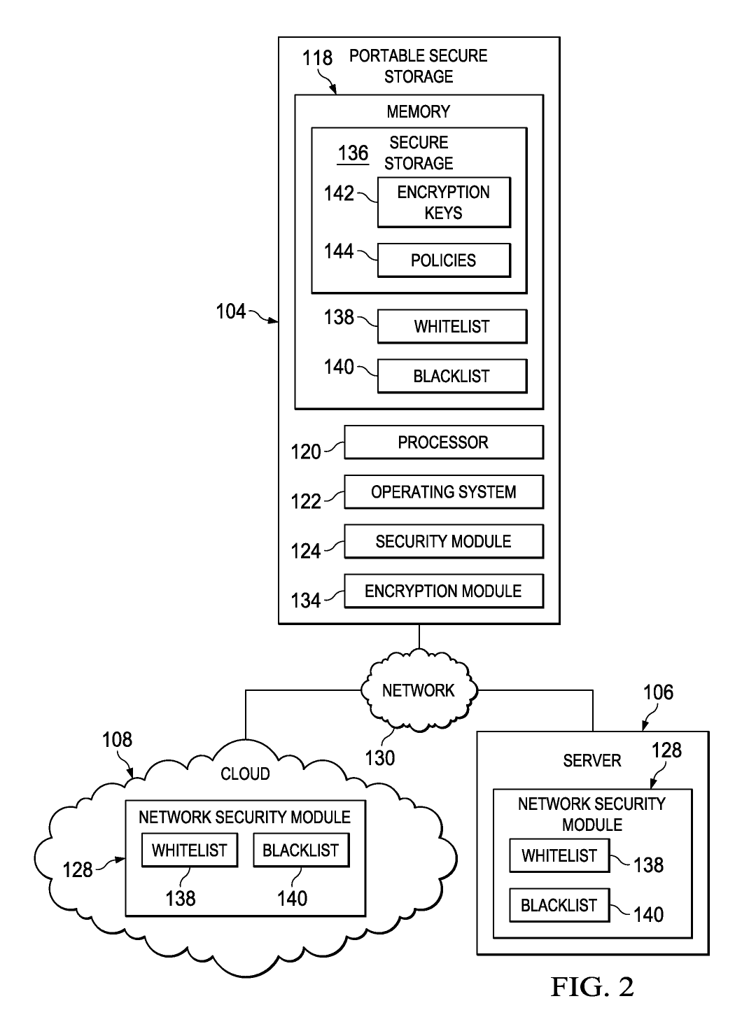

Turning to FIG. 2, FIG. 2 is a simplified block diagram of a portion of a communication system 100 that includes portable secure storage device 104. Portable secure storage device 104 can include portable memory 118, portable processor 120, portable OS 122, security module 124, and an encryption module 134. Memory 118 can include a secure storage 136, a whitelist 138, and a blacklist 140. Secure storage 136 can include encryption keys 142 and policies 144. Network security module 128 in server 106 and cloud 108 can include whitelist 138 and blacklist 140. Whitelist 138 can include known trusted applications and processes and blacklist can include know untrusted applications and processes. Security module 124 and network security module 128 can use whitelist 138 and blacklist 140 to detect malware.

Secure storage 136 can be a secure trusted execution environment (TEE) and is a protected region of memory that is typically only accessible by portable secure storage device 104 itself or through a trusted services application program interface. Generally, other processes cannot read, write, or otherwise access the data stored in secure storage 136 and secure storage 136 allows a trusted application to be protected during execution. Encryption module 124 can be configured to encrypt or decrypt data in in portable secure storage device 104 or in electronic devices 102a and 102b. Encryption keys 142 can be used by encryption module 134 to decrypt data either in portable secure storage device 104 or in electronic devices 102a and 102b. Policies 144 can limit the access, data, communication etc. to portable secure storage device 104 to help protect portable secure storage device 104 against malware attacks. Policies 144 can include but are not limited to policies for not storing executables, not storing unsigned files, not accessing files outside specific geolocations/networks, and other security policies. Encryption module 134 can be configured to allow file encryption, folder encryption, user encryption or any other policy setting. In addition, one-time password (OTP) and Public/private key based authentication can be supported using encryption keys 142 and encryption module 134. Using OTP, encryption keys 142 can change on every session or periodically which helps prevent the system being compromised if encryption keys 142 are lost or stolen.

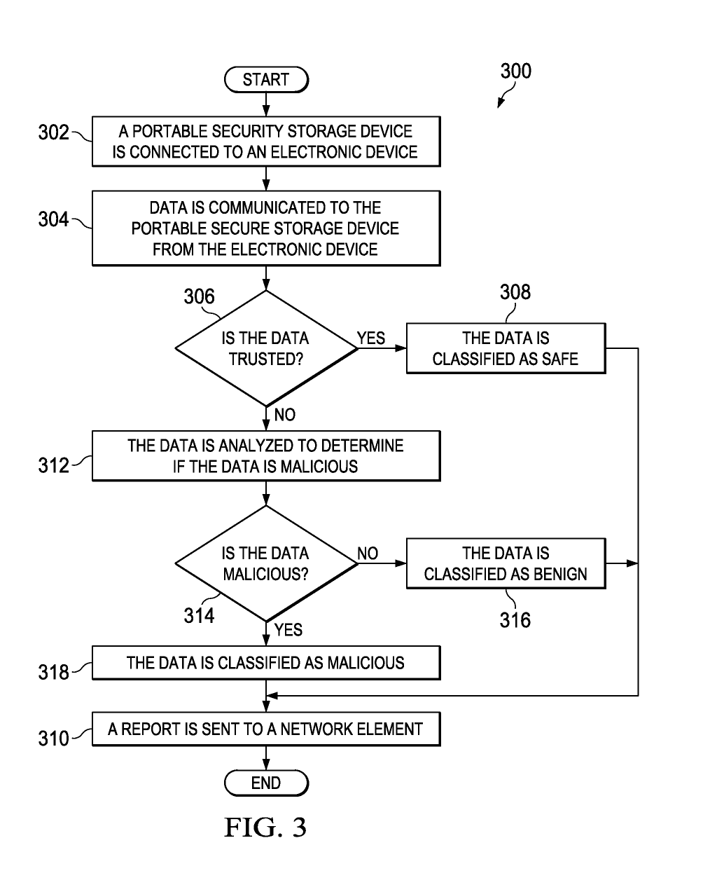

Turning to FIG. 3, FIG. 3 is an example flowchart illustrating possible operations of a flow 300 that may be associated with portable secure storage device 104, in accordance with an embodiment. In an embodiment, one or more operations of flow 300 may be performed by security module 124. At 302, a portable security storage device is connected to an electronic device. At 304, data is communicated to the portable secure storage device from the electronic device. At 306, the system determines if the data is trusted. For example, portable secure storage device 104 may use security module 124 to determine if the data is trusted. The data can be analyzed in an isolated environment without using the processor or OS for the electronic device to which portable secure storage device 104 is connected. If the data is trusted, then the data is classified as safe, as in 308. For example, the data may be found in whitelist 138. At 310, a report is sent to a network element. For example, the report can include the data, a hash of a string of the data, or some other type of information that can help analyze the data for a general malware detection system. If the data is not trusted, then the data is analyzed to determine if the data is malicious, as in 312. For example, the data may be analyzed by security module 124 or may be communicated to server 106 or cloud 108 where the data can undergo a more rigorous examination by network security module 128. At 314, the system determines if the data is malicious. If the data is not malicious, then the data is classified as benign, as in 316. At 310, a report is sent to a network element. If the data is malicious, then the data is classified as malicious, as in 318. At 310, a report is sent to a network element

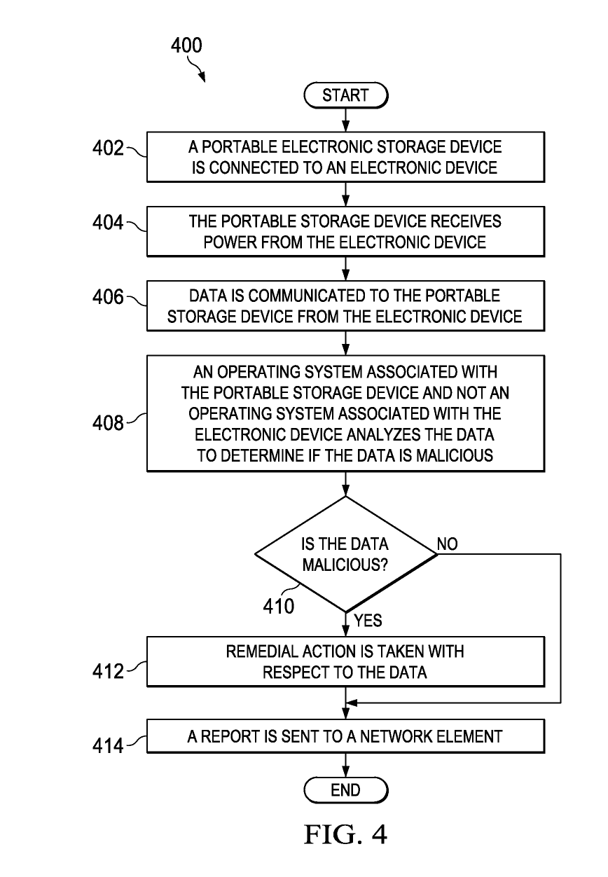

Turning to FIG. 4, FIG. 4 is an example flowchart illustrating possible operations of a flow 400 that may be associated with portable secure storage device 104, in accordance with an embodiment. In an embodiment, one or more operations of flow 400 may be performed by security module 124. At 402, a portable electronic storage device is connected to an electronic device. At 404, the portable storage device receives power from the electronic device. At 406, data is communicated to the portable storage device from the electronic device. At 408, an operating system associated with the portable storage device and not an operating system associated with the electronic device analyzes the data to determine if the data is malicious. At 410, the system determines if the data is malicious. If the data is not malicious, then a report is sent to a network element, as in 414. If the data is malicious, then remedial action is taken with respect to the data, as in 412. The remedial action can include any action that can be taken to protect portable secure storage device 104 from the malicious data. For example, portable secure storage device 104 can be configured to remove, isolate, or otherwise neutralize the malicious data from electronic device 102a. In another example, portable secure storage device 104 may block, restrict, or shut down a part of electronic device 102a that includes the malicious data, such as isolate or block a portion of memory in electronic device 102a. At 414, a report is sent to a network element. For example, the report can include the data, a hash of a string of the data, or some other type of information that can help analyze the data for a general malware detection system.

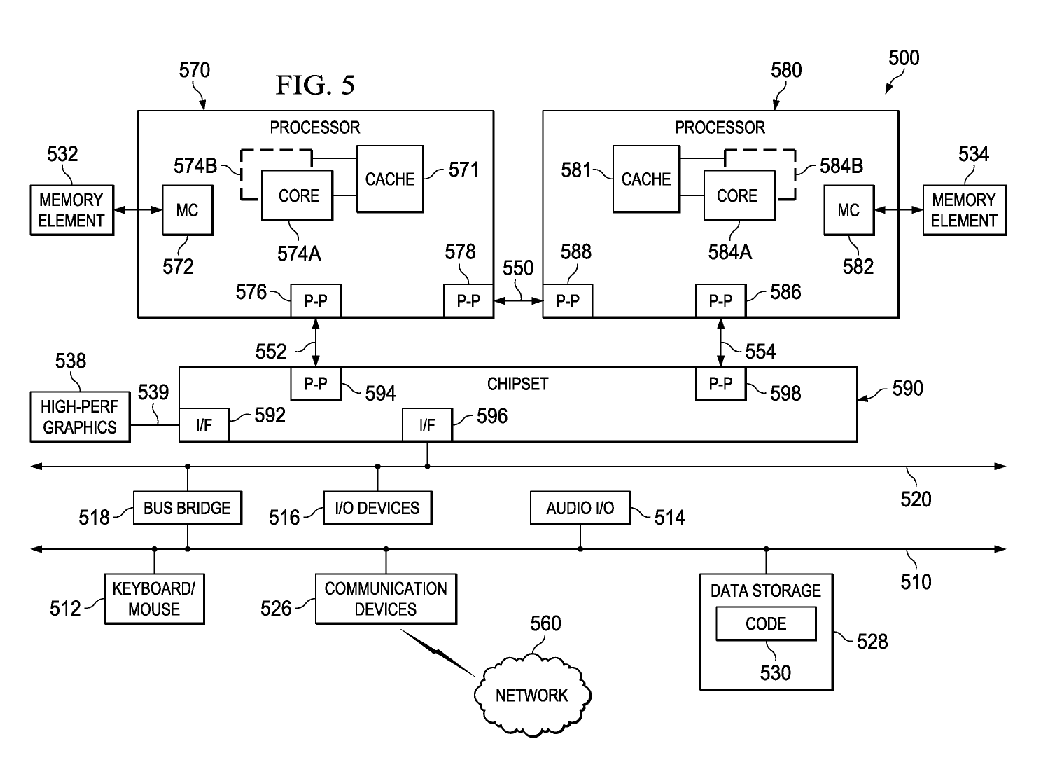

FIG. 5 illustrates a computing system 500 that is arranged in a point-to-point (PtP) configuration according to an embodiment. In particular, FIG. 5 shows a system where processors, memory, and input/output devices are interconnected by a number of point-to-point interfaces. Generally, one or more of the network elements of communication system 100 may be configured in the same or similar manner as computing system 500.

As illustrated in FIG. 5, system 500 may include several processors, of which only two, processors 570 and 580, are shown for clarity. While two processors 570 and 580 are shown, it is to be understood that an embodiment of system 500 may also include only one such processor. Processors 570 and 580 may each include a set of cores (i.e., processor cores 574A and 574B and processor cores 584A and 584B) to execute multiple threads of a program. The cores may be configured to execute instruction code in a manner similar to that discussed above with reference to FIGS. 1-4. Each processor 570, 580 may include at least one shared cache 571, 581. Shared caches 571, 581 may store data (e.g., instructions) that are utilized by one or more components of processors 570, 580, such as processor cores 574 and 584.

Processors 570 and 580 may also each include integrated memory controller logic (MC) 572 and 582 to communicate with memory elements 532 and 534. Memory elements 532 and/or 534 may store various data used by processors 570 and 580. In alternative embodiments, memory controller logic 572 and 582 may be discrete logic separate from processors 570 and 580.

Processors 570 and 580 may be any type of processor and may exchange data via a point-to-point (PtP) interface 550 using point-to-point interface circuits 578 and 588, respectively. Processors 570 and 580 may each exchange data with a chipset 590 via individual point-to-point interfaces 552 and 554 using point-to-point interface circuits 576, 586, 594, and 598. Chipset 590 may also exchange data with a high-performance graphics circuit 538 via a high-performance graphics interface 539, using an interface circuit 592, which could be a PtP interface circuit. In alternative embodiments, any or all of the PtP links illustrated in FIG. 5 could be implemented as a multi-drop bus rather than a PtP link.

Chipset 590 may be in communication with a bus 520 via an interface circuit 596. Bus 520 may have one or more devices that communicate over it, such as a bus bridge 518 and I/O devices 516. Via a bus 510, bus bridge 518 may be in communication with other devices such as a keyboard/mouse 512 (or other input devices such as a touch screen, trackball, etc.), communication devices 526 (such as modems, network interface devices, or other types of communication devices that may communicate through a computer network 560), audio I/O devices 514, and/or a data storage device 528. Data storage device 528 may store code 530, which may be executed by processors 570 and/or 580. In alternative embodiments, any portions of the bus architectures could be implemented with one or more PtP links.

The computer system depicted in FIG. 5 is a schematic illustration of an embodiment of a computing system that may be utilized to implement various embodiments discussed herein. It will be appreciated that various components of the system depicted in FIG. 5 may be combined in a system-on-a-chip (SoC) architecture or in any other suitable configuration. For example, embodiments disclosed herein can be incorporated into systems including mobile devices such as smart cellular telephones, tablet computers, personal digital assistants, portable gaming devices, etc. It will be appreciated that these mobile devices may be provided with SoC architectures in at least some embodiments.

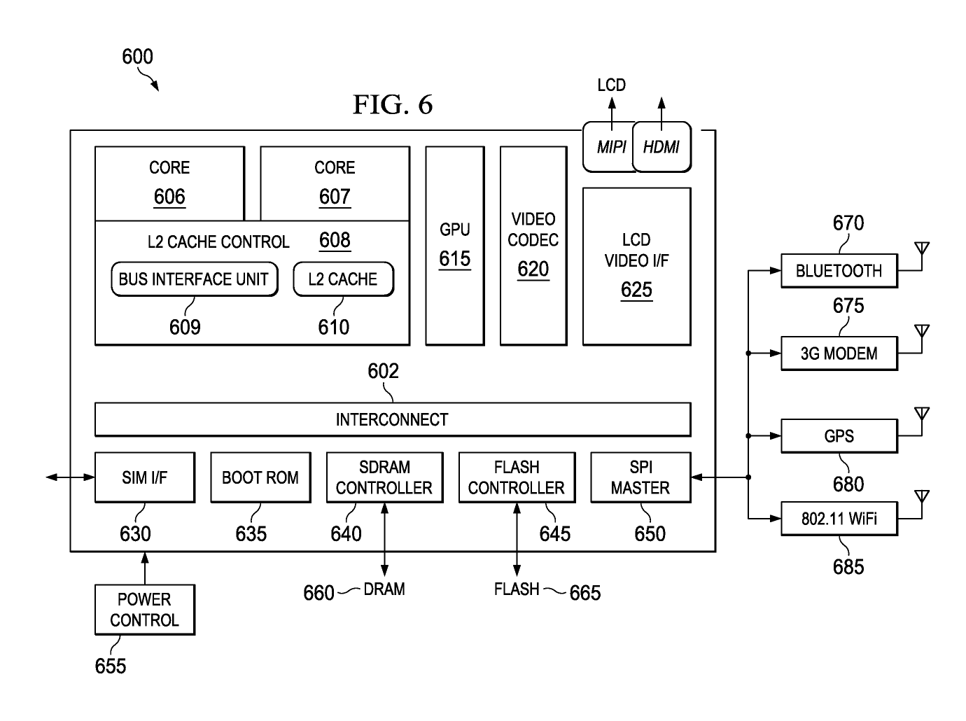

Turning to FIG. 6, FIG. 6 is a simplified block diagram associated with an example ARM ecosystem SOC 600 of the present disclosure. At least one example implementation of the present disclosure can include the portable secure storage features discussed herein and an ARM component. For example, the example of FIG. 6 can be associated with any ARM core (e.g., A-9, A-15, etc.). Further, the architecture can be part of any type of tablet, smartphone (inclusive of Android™ phones, iPhones™), iPad™, Google Nexus™, Microsoft Surface™, personal computer, server, video processing components, laptop computer (inclusive of any type of notebook), Ultrabook™ system, any type of touch-enabled input device, etc.

In this example of FIG. 6, ARM ecosystem SOC 600 may include multiple cores 606-607, an L2 cache control 608, a bus interface unit 609, an L2 cache 610, a graphics processing unit (GPU) 615, an interconnect 602, a video codec 620, and a liquid crystal display (LCD) I/F 625, which may be associated with mobile industry processor interface (MIPI)/high-definition multimedia interface (HDMI) links that couple to an LCD.

ARM ecosystem SOC 600 may also include a subscriber identity module (SIM) I/F 630, a boot read-only memory (ROM) 635, a synchronous dynamic random access memory (SDRAM) controller 640, a flash controller 645, a serial peripheral interface (SPI) master 650, a suitable power control 655, a dynamic RAM (DRAM) 660, and flash 665. In addition, one or more example embodiments include one or more communication capabilities, interfaces, and features such as instances of Bluetooth™ 670, a 3G modem 675, a global positioning system (GPS) 680, and an 802.11 Wi-Fi 685.

In operation, the example of FIG. 6 can offer processing capabilities, along with relatively low power consumption to enable computing of various types (e.g., mobile computing, high-end digital home, servers, wireless infrastructure, etc.). In addition, such an architecture can enable any number of software applications (e.g., Android™, Adobe® Flash® Player, Java Platform Standard Edition (Java SE), JavaFX, Linux, Microsoft Windows Embedded, Symbian and Ubuntu, etc.). In at least one example embodiment, the core processor may implement an out-of-order superscalar pipeline with a coupled low-latency level-2 cache.

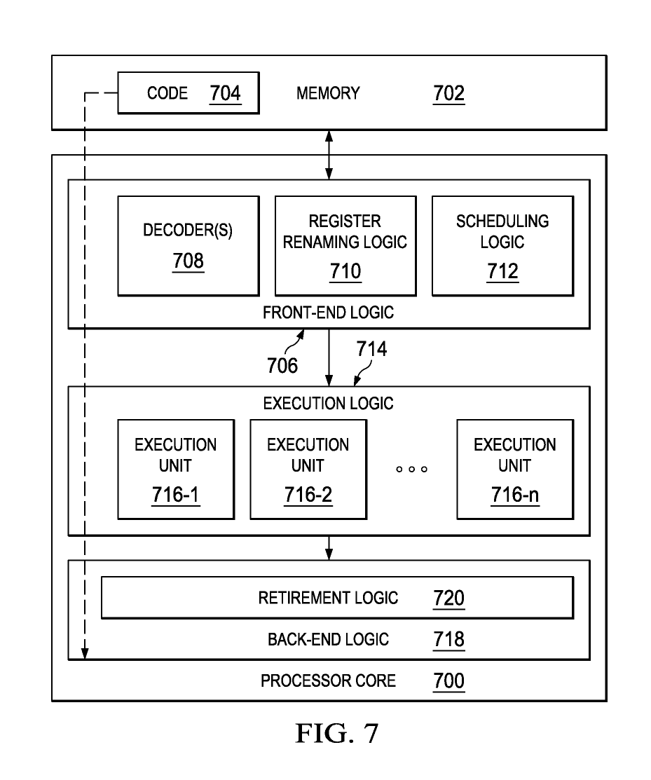

FIG. 7 illustrates a processor core 700 according to an embodiment. Processor core 700 may be the core for any type of processor, such as a micro-processor, an embedded processor, a digital signal processor (DSP), a network processor, or other device to execute code. Although only one processor core 700 is illustrated in FIG. 7, a processor may alternatively include more than one of the processor core 700 illustrated in FIG. 7. For example, processor core 700 represents one example embodiment of processors cores 574a, 574b, 574a, and 574b shown and described with reference to processors 570 and 580 of FIG. 5. Processor core 700 may be a single-threaded core or, for at least one embodiment, processor core 700 may be multithreaded in that it may include more than one hardware thread context (or “logical processor”) per core.

FIG. 7 also illustrates a memory 702 coupled to processor core 700 in accordance with an embodiment. Memory 702 may be any of a wide variety of memories (including various layers of memory hierarchy) as are known or otherwise available to those of skill in the art. Memory 702 may include code 704, which may be one or more instructions, to be executed by processor core 700. Processor core 700 can follow a program sequence of instructions indicated by code 704. Each instruction enters a front-end logic 706 and is processed by one or more decoders 708. The decoder may generate, as its output, a micro operation such as a fixed width micro operation in a predefined format, or may generate other instructions, microinstructions, or control signals that reflect the original code instruction. Front-end logic 706 also includes register renaming logic 710 and scheduling logic 712, which generally allocate resources and queue the operation corresponding to the instruction for execution.

Processor core 700 can also include execution logic 714 having a set of execution units 716-1 through 716-N. Some embodiments may include a number of execution units dedicated to specific functions or sets of functions. Other embodiments may include only one execution unit or one execution unit that can perform a particular function. Execution logic 714 performs the operations specified by code instructions.

After completion of execution of the operations specified by the code instructions, back-end logic 718 can retire the instructions of code 704. In one embodiment, processor core 700 allows out of order execution but requires in order retirement of instructions. Retirement logic 720 may take a variety of known forms (e.g., re-order buffers or the like). In this manner, processor core 700 is transformed during execution of code 704, at least in terms of the output generated by the decoder, hardware registers and tables utilized by register renaming logic 710, and any registers (not shown) modified by execution logic 714.

Although not illustrated in FIG. 7, a processor may include other elements on a chip with processor core 700, at least some of which were shown and described herein with reference to FIG. 5. For example, as shown in FIG. 5, a processor may include memory control logic along with processor core 700. The processor may include I/O control logic and/or may include I/O control logic integrated with memory control logic.

Note that with the examples provided herein, interaction may be described in terms of two, three, or more network elements. However, this has been done for purposes of clarity and example only. In certain cases, it may be easier to describe one or more of the functionalities of a given set of flows by only referencing a limited number of network elements. It should be appreciated that communication system 100 and their teachings are readily scalable and can accommodate a large number of components, as well as more complicated/sophisticated arrangements and configurations. Accordingly, the examples provided should not limit the scope or inhibit the broad teachings of communication systems 100a and 100b as potentially applied to a myriad of other architectures.

It is also important to note that the operations in the preceding flow diagrams (i.e., FIGS. 3 and 4) illustrate only some of the possible correlating scenarios and patterns that may be executed by, or within, communication system 100. Some of these operations may be deleted or removed where appropriate, or these operations may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by communication system 100 in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations. Additionally, although communication system 100 have been illustrated with reference to particular elements and operations that facilitate the communication process, these elements and operations may be replaced by any suitable architecture, protocols, and/or processes that achieve the intended functionality of communication system 100.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

### Other Notes and Examples

In Example A1, an apparatus can include a security module configured, where the security module is configured to receive data from an electronic device, where the apparatus is removably connected to the electronic device and receives its operating power from the electronic device and analyze the data using at least a portion of a protected area of memory located in the apparatus to determine if the data is malicious, where the protected area of memory is not accessible by the electronic device.

In Example, A2, the subject matter of Example A1 can optionally include an operating system, where the operating system is independent of an operating system of the electronic device.

In Example A3, the subject matter of any one of Examples A1-A2 can optionally include a processor, where the processor is independent of a processor in the electronic device.

In Example A4, the subject matter of any one of Examples A1-A3 can optionally include an encryption module, where the encryption module can encrypt and decrypt data located in the protected area of memory.

In Example A5, the subject matter of any one of Examples A1-A4 can optionally include where the security module is further configured to take remedial action with respect to the data if the data is determined to be malicious.

In Example A6, the subject matter of any one of Examples A1-A5 can optionally include where the apparatus is a universal serial bus flash drive.

In, Example C1 is at least one machine readable storage medium having one or more instructions that when executed by at least one processor, cause the at least one processor to receive data from an electronic device, where the at least one computer-readable medium is included in a portable electronic device and the portable electronic device receives its operating power from the electronic device and analyze the data using at least a portion of a protected area of memory located in the portable electronic device to determine if the data is malicious, where the protected area of memory is not accessible by the electronic device.

In Example C2, the subject matter of Example C1 can optionally include where the portable electronic device includes an operating system that is independent of an operating system of the electronic device.

In Example C3, the subject matter of any one of Examples C1-C2 can optionally include where the portable electronic device includes a processor that is independent of a processor in the electronic device.

In Example C4, the subject matter of any one of Examples C1-C3 can optionally include where the one or more instructions that when executed by the at least one processor, further cause the processor to take remedial action with respect to the data if the data is determined to be malicious.

In Example C5, the subject matter of any one of Examples C1-C4 can optionally include where the portable electronic device is a universal serial bus flash drive.

Example M1 is a method including receiving data at a portable electronic device, from an electronic device, where the portable electronic device receives its operating power from the electronic device and analyzing the data using at least a portion of a protected area of memory located in the portable electronic device to determine if the data is malicious, where the protected area of memory is not accessible by the electronic device.

In Example M2, the subject matter of Example M1 can optionally include where the portable electronic device includes an operating system that is independent of an operating system of the electronic device.

In Example M3, the subject matter of any one of the Examples M1-M2 can optionally include where the portable electronic device includes a processor that is independent of a processor in the electronic device.

In Example M4, the subject matter of any one of the Examples M1-M3 can optionally include taking remedial action with respect to the data if the data is determined to be malicious.

In Example M5, the subject matter of any one of the Examples M1-M4 can optionally include where the portable electronic device is a universal serial bus flash drive.

Example S1 is a system including a security module configured for receiving data at a portable electronic device, from an electronic device, where the portable electronic device receives its operating power from the electronic device and analyzing the data using at least a portion of a protected area of memory located in the portable electronic device to determine if the data is malicious, where the protected area of memory is not accessible by the electronic device.

In Example S2, the subject matter of Example S1 can optionally include where the portable electronic device includes an operating system that is independent of an operating system of the electronic device.

In Example S3, the subject matter of any one of the Examples S1-S2 can optionally include where the portable electronic device includes a processor that is independent of a processor in the electronic device.

In Example S4, the subject matter of any one of the Examples S1-S3 can optionally include where the portable electronic device is a universal serial bus flash drive.

Example X1 is a machine-readable storage medium including machine-readable instructions to implement a method or realize an apparatus as in any one of the Examples A1-A7, or M1-M5. Example Y1 is an apparatus comprising means for performing of any of the Example methods M1-M5. In Example Y2, the subject matter of Example Y1 can optionally include the means for performing the method comprising a processor and a memory. In Example Y3, the subject matter of Example Y2 can optionally include the memory comprising machine-readable instructions.

What is claimed is:

1. An apparatus comprising:
a security module configured to:
receive data from an electronic device, wherein the apparatus is removably connected to the electronic device and receives its operating power from the electronic device; and
analyze the data using at least a portion of a protected area of memory located in the apparatus to determine if the data is malicious, wherein the protected area of memory is not accessible by the electronic device.

2. The apparatus of claim 1, further comprising:
an operating system, wherein the operating system is independent of an operating system of the electronic device.

3. The apparatus of claim 1, further comprising:
a processor, wherein the processor is independent of a processor in the electronic device.

4. The apparatus of claim 1, further comprising:
an encryption module, wherein the encryption module can encrypt and decrypt data located in the protected area of memory.

5. The apparatus of claim 1, wherein the security module is further configured to:
take remedial action with respect to the data if the data is determined to be malicious.

6. The apparatus of claim 1, wherein the apparatus is a universal serial bus flash drive.

7. At least one computer-readable medium comprising one or more instructions that when executed by at least one processor, cause the processor to:
receive data from an electronic device, wherein the at least one computer-readable medium is included in a portable electronic device and the portable electronic device receives its operating power from the electronic device; and
analyze the data using at least a portion of a protected area of memory located in the portable electronic device to determine if the data is malicious, wherein the protected area of memory is not accessible by the electronic device.

8. The at least one computer-readable medium of claim 7, wherein the portable electronic device includes an operating system that is independent of an operating system of the electronic device.

9. The at least one computer-readable medium of claim 7, wherein the portable electronic device includes a processor that is independent of a processor in the electronic device.

10. The at least one computer-readable medium of claim 7, further comprising one or more instructions that when executed by the at least one processor further cause the processor to:
take remedial action with respect to the data if the data is determined to be malicious.

11. The at least one computer-readable medium of claim 7, wherein the portable electronic device is a universal serial bus flash drive.

12. A method comprising:
receiving data at a portable electronic device, from an electronic device, wherein the portable electronic device receives its operating power from the electronic device; and
analyzing the data using at least a portion of a protected area of memory located in the portable electronic device to determine if the data is malicious, wherein the protected area of memory is not accessible by the electronic device.

13. The method of claim 12, wherein the portable electronic device includes an operating system that is independent of an operating system of the electronic device.

14. The method of claim 12, wherein the portable electronic device includes a processor that is independent of a processor in the electronic device.

15. The method of claim 12, further comprising:
taking remedial action with respect to the data if the data is determined to be malicious.

16. The method of claim 12, wherein the portable electronic device is a universal serial bus flash drive.

17. A system comprising:
a security module configured for:
receiving data at a portable electronic device, from an electronic device, wherein the portable electronic device receives its operating power from the electronic device; and
analyzing the data using at least a portion of a protected area of memory located in the portable electronic device to determine if the data is malicious, wherein the protected area of memory is not accessible by the electronic device.

18. The system of claim 17, wherein the portable electronic device includes an operating system that is independent of an operating system of the electronic device.

19. The system of claim 17, wherein the portable electronic device includes a processor that is independent of a processor in the electronic device.

20. The system of claim 17, wherein the portable electronic device is a universal serial bus flash drive.
